(19) United States
(12) Patent Application Publication
(10) Pub. No.: US 2026/0131695 A1
(43) Pub. Date: May 14, 2026

(54) BATTERY MONITORING DEVICE

(71) Applicant: TOYOTA JIDOSHA KABUSHIKI KAISHA, Toyota-shi (JP)

(72) Inventor: Kazuaki KAMIYA, Toki-shi (JP)

(73) Assignee: TOYOTA JIDOSHA KABUSHIKI KAISHA, Toyota-shi (JP)

(21) Appl. No.: 19/279,048

(22) Filed: Jul. 24, 2025

(30) Foreign Application Priority Data
Nov. 12, 2024 (JP) 2024-197177

(51) Int. Cl. B60L 58/12

(52) U.S. Cl. CPC B60L 58/12; B60L 2240/545

(57) ABSTRACT

A battery monitoring device includes: an SOC sensor that detects an SOC of a battery; an ambient temperature sensor that detects an ambient temperature of the battery; a load sensor that detects a restraint load of the battery; a battery temperature sensor that detects a temperature of the battery; and an ECU that determines an operation cycle of the battery temperature sensor based on the SOC, the ambient temperature, and the restraint load, and operates the battery temperature sensor in the determined operation cycle.

### CROSS-REFERENCE TO RELATED APPLICATION

This application claims priority to Japanese Patent Application No. 2024-197177 filed on Nov. 12, 2024. The disclosure of the above-identified application, including the specification, drawings, and claims, is incorporated by reference herein in its entirety.

### BACKGROUND

### 1. Technical Field

The present disclosure relates to a battery monitoring device.

### 2. Description of Related Art

Japanese Unexamined Patent Application Publication No. 2021-036485 (JP 2021-036485 A) describes a method of cooling a power supply device, the method including detecting a state of charge (SOC) and an ambient temperature of a battery, determining whether a predetermined temperature evaluation criterion is met based on the detected SOC and temperature, and operating a cooling mechanism that cools the battery when it is determined that the temperature evaluation criterion is not met.

### SUMMARY

The cooling method described in JP 2021-036485 A uses only the SOC and the ambient temperature of the battery for temperature evaluation, and there is room for improvement in terms of improving accuracy.

There is an issue that the risk of smoke generation increases when the interval of detecting the battery temperature is long, and power consumption increases when the interval of detecting the battery temperature is long.

An object of the present disclosure is to provide a battery monitoring device that can detect the temperature of a battery at appropriate timings.

An aspect of the present disclosure provides a battery monitoring device including: a state of charge (SOC) sensor that detects an SOC of a battery; an ambient temperature sensor that detects an ambient temperature of the battery; a load sensor that detects a restraint load of the battery; a battery temperature sensor that detects a temperature of the battery; and a control device that determines an operation cycle of the battery temperature sensor based on the SOC, the ambient temperature, and the restraint load, and operates the battery temperature sensor in the determined operation cycle.

According to the present disclosure, the temperature of a battery can be detected at appropriate timings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates the overall configuration of a vehicle provided with a battery cooling device according to an embodiment;

FIG. 2A illustrates an example of the risk of smoke generation from a battery 5;

FIG. 2B illustrates an example of the risk of smoke generation from the battery 5;

FIG. 2C illustrates an example of the risk of smoke generation from the battery 5;

FIG. 3 illustrates an example of a check of a temperature TB of the battery 5; and

FIG. 4 is a flowchart illustrating the procedure for control of monitoring of the battery 5.

### DETAILED DESCRIPTION OF EMBODIMENTS

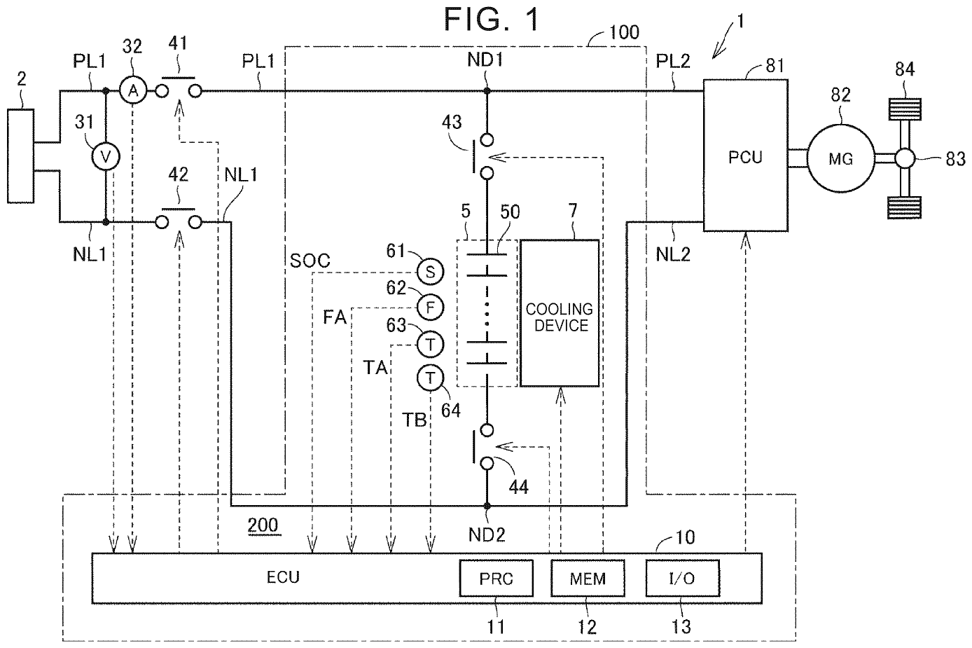

An embodiment will be described below with reference to the drawings. FIG. 1 schematically illustrates the overall configuration of a vehicle provided with a battery cooling device according to an embodiment. A vehicle 1 is, for example, a battery electric vehicle. The vehicle 1 is configured to allow external charging (so-called plug-in charging) in which power is supplied from a charger (not illustrated) to the vehicle 1 to charge an in-vehicle battery 5. It is not essential that the vehicle 1 should be configured to be externally chargeable. The vehicle 1 may be a normal hybrid electric vehicle that is not externally chargeable.

The vehicle 1 includes an inlet 2, charging lines PL1, NL1, a voltage sensor 31, a current sensor 32, charging relays 41, 42, system main relays (SMRs) 43, 44, power lines PL2, NL2, the battery 5, a state of charge (SOC) sensor 61, an ambient temperature sensor 63, a load sensor 62, a battery temperature sensor 64, a cooling device 7, a power control unit (PCU) 81, a motor generator 82, a power transmission gear 83, drive wheels 84, and an electronic control unit (ECU) 10.

The SOC sensor 61, the ambient temperature sensor 63, the load sensor 62, the battery temperature sensor 64, and the ECU 10 constitute a battery monitoring device 200.

The inlet (charging port) 2 is configured to enable insertion of a connector (not illustrated) of a charging cable with mechanical coupling such as fitting.

The voltage sensor 31 is electrically connected between the charging line PL1 and the charging line NL1, on the inlet 2 side with respect to the charging relay 41. The voltage sensor 31 detects a direct current (DC) voltage between the charging line PL1 and the charging line NL1, and outputs the detection result to the ECU 10. The current sensor 32 is provided, for example, in the charging line PL1. The current sensor 32 detects a current that flows through the charging line PL1, and outputs the detection result to the ECU 10. The ECU 10 can calculate the power supplied from a charger (not illustrated) (the amount of charge of the battery 5) based on the detection results from the voltage sensor 31 and the current sensor 32.

The charging relay 41 is connected to the charging line PL1, and the charging relay 42 is connected to the charging line NL1. The closing/opening of the charging relays 41, 42 is controlled according to a command from the ECU 10. When the charging relays 41, 42 are closed and the SMRs 43, 44 are closed, power transmission between the inlet 2 and the battery 5 is enabled.

The battery 5 is an assembled battery including a plurality of cells 50. Each of the cells 50 is a lithium ion secondary battery. The battery 5 supplies power for generating a drive force for the vehicle 1. In addition, the battery 5 stores power generated by the motor generator 82. A positive electrode of the battery 5 is electrically connected to a node ND1 by way of the SMR 43. The node ND1 is electrically connected to the charging line PL1 and the power line PL2. Likewise, a negative electrode of the battery 5 is electrically connected to a node ND2 by way of the SMR 44. The node ND2 is electrically connected to the charging line NL1 and the power line NL2. The closing/opening of the SMRs 43, 44 is controlled according to a command from the ECU 10.

The cooling device 7 is, for example, a cooling device of a liquid cooling type in which a liquid refrigerant is used. The cooling device 7 cools the battery 5 according to a command from the ECU 10.

The PCU 81 is electrically connected between the power lines PL2, NL2 and the motor generator 82. The PCU 81 includes a converter and an inverter (neither of which is illustrated), and drives the motor generator 82 according to a command from the ECU 10.

The motor generator 82 is an alternating current (AC) rotary electric machine, for example a permanent magnet synchronous motor including a rotor in which a permanent magnet is embedded. The output torque of the motor generator 82 is transmitted to the drive wheels 84 through the power transmission gear 83, causing the vehicle 1 to travel. Furthermore, the motor generator 82 can generate power using the rotational force of the drive wheels 84 when the vehicle 1 is braking. The power generated by the motor generator 82 is converted by the PCU 81 into charging power for the battery 5.

The ECU 10 includes a processor 11 such as a central processing unit (CPU), a memory 12 such as a read only memory (ROM) and a random access memory (RAM), and an input/output port 13. The ECU 10 controls the devices according to signals from the various sensors, etc., so as to bring the vehicle 1 into a desired state. The ECU 10 may be divided into a plurality of ECUs for respective functions (such as a battery ECU, a motor generator (MG) ECU, etc.).

The SOC sensor 61 detects the SOC of the battery 5. The SOC sensor 61 may directly detect the SOC of the battery 5. The SOC sensor may detect a voltage VB of the battery 5 and a current IB input to and output from the battery 5, and detect the SOC of the battery 5 based on the voltage VB and the current IB.

The ambient temperature sensor 63 detects an ambient temperature TA of the battery 5. The ambient temperature sensor 63 may directly detect the ambient temperature TA of the battery 5. The ambient temperature sensor 63 may detect a current IB input to and output from the battery 5, and detect the ambient temperature TA of the battery 5 based on the current IB.

The load sensor 62 detects a restraint load FA of the battery 5. For example, the load sensor 62 may be sandwiched between the cells 50 of the battery 5 to detect the restraint load FA of the battery 5.

The battery temperature sensor 64 detects a temperature TB of the battery 5. The battery temperature sensor 64 operates intermittently.

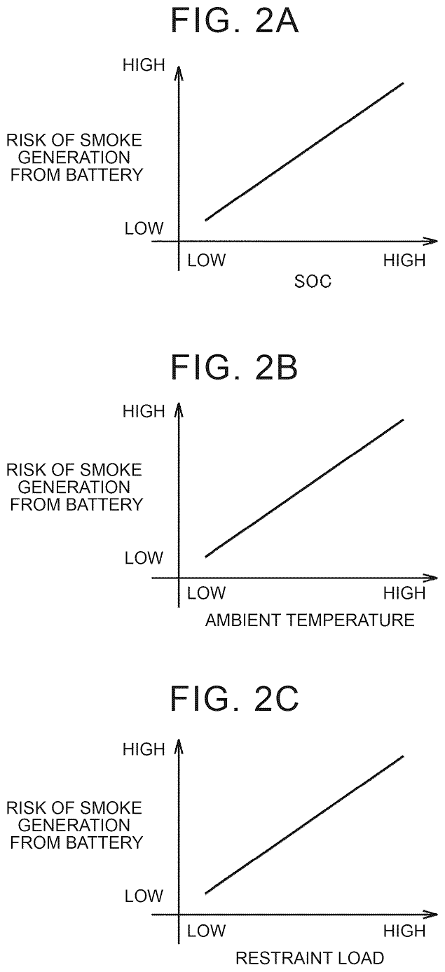

FIGS. 2A, 2B, and 2C each illustrate an example of the risk of smoke generation from the battery 5. As illustrated in FIG. 2A, the risk of smoke generation from the battery 5 becomes higher as the SOC of the battery 5 becomes higher. As illustrated in FIG. 2B, the risk of smoke generation from the battery 5 becomes higher as the ambient temperature TA of the battery 5 becomes higher. As illustrated in FIG. 2C, the risk of smoke generation from the battery 5 becomes higher as the restraint load FA of the battery 5 becomes higher.

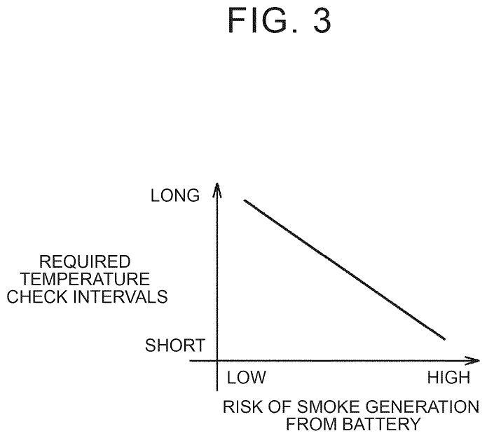

FIG. 3 illustrates an example of a check of the temperature TB of the battery 5.

When the risk of smoke generation from the battery increases, it is necessary to shorten the interval at which the temperature TB of the battery 5 is checked.

In the present embodiment, the cycle in which the battery temperature sensor 64 is operated to detect the temperature TB of the battery 5 is determined based on the above consideration.

The ECU 10 determines the operation cycle of the battery temperature sensor 64 based on the SOC of the battery 5, the ambient temperature TA of the battery 5, and the restraint load FA of the battery 5. The ECU 10 operates the battery temperature sensor 64 in the determined operation cycle. The cooling device 7 is controlled based on the temperature TB of the battery 5 detected by the battery temperature sensor 64.

The ECU 10 calculates a variable α based on the SOC of the battery 5, calculates a variable β based on the ambient temperature TA of the battery 5, and calculates a variable γ based on the restraint load FA of the battery 5, and increases the operation cycle of the battery temperature sensor 64 as the sum of the variables α, β, and γ is larger.

The ECU 10 sets the variable α to a first value when the SOC of the battery 5 is within a first range, sets the variable α to a second value smaller than the first value when the SOC of the battery 5 is within a second range larger than the first range, and sets the variable α to a third value smaller than the second value when the SOC of the battery 5 is within a third range larger than the second range.

The ECU 10 sets the variable β to a first value when the ambient temperature TA of the battery 5 is within a first range, sets the variable β to a second value smaller than the first value when the ambient temperature TA of the battery 5 is within a second range larger than the first range, and sets the variable β to a third value smaller than the second value when the ambient temperature TA of the battery 5 is within a third range larger than the second range.

The ECU 10 sets the variable γ to a first value when the restraint load FA of the battery 5 is within a first range, sets the variable γ to a second value smaller than the first value when the restraint load FA of the battery 5 is within a second range larger than the first range, and sets the variable γ to a third value smaller than the second value when the restraint load FA of the battery 5 is within a third range larger than the second range.

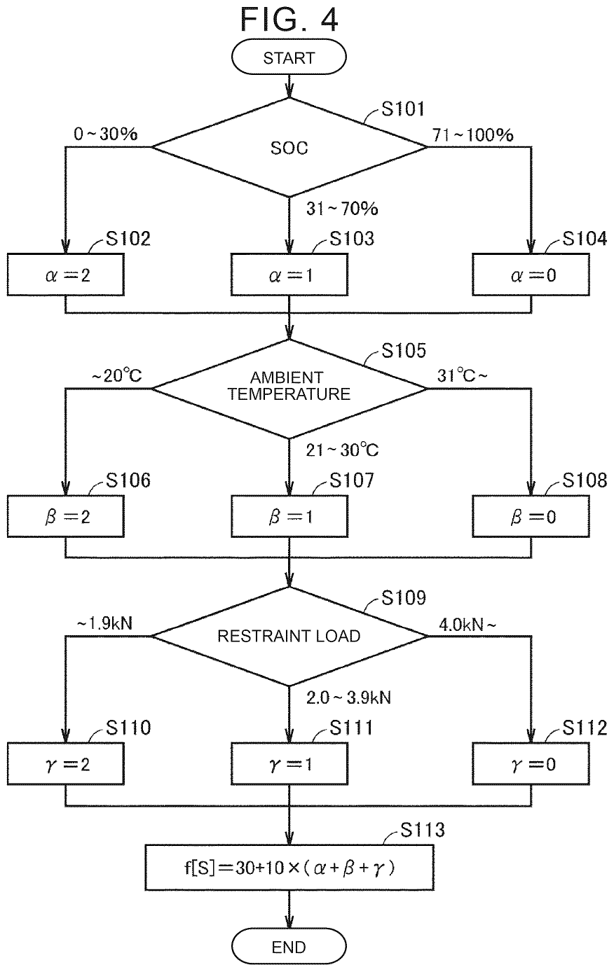

FIG. 4 is a flowchart illustrating the procedure for control of monitoring of the battery 5.

In step S101, the ECU 10 acquires the SOC of the battery 5 detected by the SOC sensor 61. When the SOC of the battery 5 is 0% to 30%, the process proceeds to step S102; when the SOC of the battery 5 is 31% to 70%, the process proceeds to step S103; and when the SOC of the battery 5 is 71% to 100%, the process proceeds to step S104.

In step S102, the ECU 10 sets the variable α to 2.

In step S103, the ECU 10 sets the variable α to 1.

In step S104, the ECU 10 sets the variable α to 0.

In step S105, the ECU 10 acquires the ambient temperature TA of the battery 5 detected by the ambient temperature sensor 63. When the ambient temperature TA of the battery 5 is between 0° C. and 20° C., the process proceeds to step S106; when the ambient temperature TA of the battery 5 is between 21° C. and 30° C., the process proceeds to step S107; and when the ambient temperature TA of the battery 5 is 31° C. or higher, the process proceeds to step S108.

In step S106, the ECU 10 sets the variable β to 2.

In step S107, the ECU 10 sets the variable β to 1.

In step S108, the ECU 10 sets the variable β to 0.

In step S109, the ECU 10 acquires the restraint load FA of the battery 5 detected by the load sensor 62. When the restraint load FA of the battery 5 is 1.9 kN or less, the process proceeds to step S110; when the restraint load FA of the battery 5 is 2.0 kN to 3.9 kN, the process proceeds to step S111; and when the restraint load FA of the battery 5 is 4.0 kN or more, the process proceeds to step S112.

In step S110, the ECU 10 sets the variable γ to 2.

In step S111, the ECU 10 sets the variable γ to 1.

In step S112, the ECU 10 sets the variable γ to 0.

In step S113, the ECU 10 determines the operation interval (activation interval) f [s] of the battery temperature sensor 64 by the following equation (1).

$$f = 30 + 10 \times ( α + β + γ ) \qquad ( 1 )$$

As described above, according to the present embodiment, the operation cycle of the battery temperature sensor is determined based on the SOC of the battery, the ambient temperature of the battery, and the restraint load of the battery, making it possible to reduce the risk of smoke generation with a high accuracy and reduce power consumption.

The outside air temperature may be used instead of the ambient temperature of the battery 5.

The embodiment disclosed herein should be considered to be exemplary in all respects and not restrictive. The scope of the present disclosure is defined by the claims rather than by the above description, and is intended to include all modifications that fall within the meaning and scope equivalent to those of the claims.

What is claimed is:

1. A battery monitoring device comprising:
a state of charge (SOC) sensor that detects an SOC of a battery;
an ambient temperature sensor that detects an ambient temperature of the battery;
a load sensor that detects a restraint load of the battery;
a battery temperature sensor that detects a temperature of the battery; and
a control device that determines an operation cycle of the battery temperature sensor based on the SOC, the ambient temperature, and the restraint load, and operates the battery temperature sensor in the determined operation cycle.

2. The battery monitoring device according to claim 1, wherein the control device calculates a first variable based on the SOC, calculates a second variable based on the ambient temperature, calculates a third variable based on the restraint load, and increases the operation cycle as a sum of the first variable, the second variable, and the third variable is larger.

3. The battery monitoring device according to claim 2, wherein the control device sets the first variable to a first value when the SOC is within a first range, sets the first variable to a second value smaller than the first value when the SOC is within a second range larger than the first range, and sets the first variable to a third value smaller than the second value when the SOC is within a third range larger than the second range.

4. The battery monitoring device according to claim 2, wherein the control device sets the second variable to a first value when the ambient temperature is within a first range, sets the second variable to a second value smaller than the first value when the ambient temperature is within a second range larger than the first range, and sets the second variable to a third value smaller than the second value when the ambient temperature is within a third range larger than the second range.

5. The battery monitoring device according to claim 2, wherein the control device sets the third variable to a first value when the restraint load is within a first range, sets the third variable to a second value smaller than the first value when the restraint load is within a second range larger than the first range, and sets the third variable to a third value smaller than the second value when the restraint load is within a third range larger than the second range.
